(19) United States
(12) Patent Application Publication
(10) Pub. No.: US 2025/0115510 A1
(43) Pub. Date: Apr. 10, 2025

(54) PLATE GLASS MANUFACTURING EQUIPMENT AND MANUFACTURING METHOD

(71) Applicant: QINGDAO FUSION PHOTOELECTRIC TECHNOLOGY CO., LTD., QINGDAO (CN)

(72) Inventors: Yunxiao ZHANG, QINGDAO (CN); Shujun GAO, QINGDAO (CN); Haijing LIN, QINGDAO (CN); Zhenchao ZHANG, QINGDAO (CN); Xingchen SONG, QINGDAO (CN); Wenming DING, QINGDAO (CN)

(73) Assignee: QINGDAO FUSION PHOTOELECTRIC TECHNOLOGY CO., LTD., QINGDAO (CN)

(21) Appl. No.: 18/983,301

(22) Filed: Dec. 16, 2024

Related U.S. Application Data
(63) Continuation-in-part of application No. PCT/CN2023/135820, filed on Dec. 1, 2023.

(30) Foreign Application Priority Data
Dec. 13, 2022 (CN) 202211593579.8
Sep. 15, 2023 (CN) 202311197353.0

(51) Int. Cl. C03B 17/06; C03B 21/02

(52) U.S. Cl. CPC C03B 17/064; C03B 17/068; C03B 21/02

(57) ABSTRACT

A plate glass manufacturing device and manufacturing method, the device comprises a glass former body (100) for shaping molten glass; and the body comprises a first outer plate (101) and a second outer plate (102), a forming cavity (103) is formed therebetween; a partition (104) is vertically arranged in a middle part between the first outer plate (101) and the second outer plate (102), dividing an upper part of the forming cavity into a first cavity (1031) and a second cavity (1032); and the forming cavity (103) further includes a glass ribbon cavity (1033) located at a lower part of the forming cavity. The device can well complete the forming of plate glass and has the advantage of fast forming speed.

The present application is a continuation-in-part application of international application PCT/CN2023/135820, filed on Dec. 1, 2023, which claims the priority benefit of Chinese application No. 202211593579.8, filed on Dec. 13, 2022, entitled “Plate Glass Forming Equipment and Forming Method”, and Chinese application No. 2023111950353.0, filed on Sep. 15, 2023, entitled “High-generation OLED Plate Glass Manufacturing Equipment and process”, the entirety of the above identified applications are hereby incorporated by reference.

### TECHNICAL FIELD

The present application belongs to the field of plate glass production technology, and relates to plate glass manufacturing equipment and manufacturing method.

### BACKGROUND ART

At present, the key device in a plate glass forming process is the glass forming trough. The traditional plate glass forming trough is an overflow type. During the overflow process, the contact area with air is too large, resulting in the attachment of pollutants and affecting the quality of the glass. The heating method of the traditional plate glass forming trough is external muffle furnace heating, which is large in size and low in efficiency, and the heating effect is uneven, which is easy to produce uneven textures, resulting in a high incidence of defective products. The traditional muffle furnace heating method has inaccurate temperature control, which can easily lead to uneven heating of the glass, affecting the forming, affecting the internal stress, causing fragments or breaking, and frequent defects.

Chinese application CN112279496A discloses an improved device for manufacturing glass ribbon. The device includes a stretching trough, which has a lower elongated nozzle opening, through which the molten glass can be discharged downward, and the stretching trough includes a direct heating device and an indirect heating device.

### SUMMARY OF THE INVENTION

The present application provides a plate glass manufacturing device and manufacturing method, which is able to well complete the forming of the plate glass and has the advantage of fast forming speed.

A first aspect of the present application provides a plate glass manufacturing device, comprising a glass former body for shaping molten glass; and the glass former body comprises:
a first outer plate and a second outer plate arranged symmetrically at intervals, a forming cavity is formed between the first outer plate and the second outer plate, and the molten glass flows from top to bottom in the forming cavity;
a partition vertically arranged in a middle part between the first outer plate and the second outer plate, and the partition divides an upper part of the forming cavity into a first cavity and a second cavity;
the forming cavity also includes a glass ribbon cavity located at a lower part of the forming cavity, wherein an end of the partition is located at an upper part of the glass ribbon cavity, an upper end of the glass ribbon cavity is a pull-down outlet of the molten glass, and the pull-down outlet is a double-slit structure and is communicated with a bottom of the first cavity and a bottom of the second cavity respectively;
the molten glass flows from top to bottom in the first cavity and the second cavity, and the molten glass in the first cavity and the second cavity flows into the glass ribbon cavity simultaneously.

In some embodiments, tops of the first outer plate and the second outer plate are higher than a top of the partition; sides of the partition facing the first outer plate and the second outer plate are fixedly provided with first temperature sensors respectively; side of the first outer plate and side of the second outer plate both facing the partition are fixedly provided with first temperature sensors and first regulating electrodes respectively; the first temperature sensors and first regulating electrodes are electrically connected with a signal processor.

Each of the first temperature sensor is configured to collect real-time temperature and transmit the collected temperature to the signal processor; the signal processor is configured to receive the temperature collected by the temperature sensor and compare with a set first target temperature; when the collected temperature is lower than the first target temperature, an instruction is sent to the first regulating electrode; and the first regulating electrode is configured to receive the instruction from the signal processor and adjust the temperature.

In some embodiments, physical property sensors and second temperature sensors are fixedly arranged on both sides of the glass ribbon cavity, and the physical property sensors are electrically connected to the signal processor. Each of the physical property sensor is a camera, and is configured to take real-time photos and send the taken photos to the signal processor; the signal processor is configured to receive the photos taken by the physical property sensor, analyze the thickness, light transmittance, impurity content, and flow velocity parameters of the glass ribbon, and determine whether these parameters meet preset ranges; if not, the first regulating electrode is controlled to adjust the temperature in the forming cavity to improve these parameters. Each of the second temperature sensor is configured to collect real-time temperature and send the collected temperature to the signal processor; the signal processor is configured to receive the temperature collected by the second temperature sensor and compare with a set second target temperature; when the collected temperature is lower than the second target temperature, an instruction is sent to the first regulating electrode; and the first regulating electrode is configured to receive the instruction from the signal processor and adjust the temperature in the forming cavity.

In some embodiments, the first outer plate and the second outer plate are both bent shape and have the same structure, and each of the first outer plate and the second outer plate includes a vertical plate and an inclined plate respectively, each inclined plate is located at a bottom of the vertical plate, and a distance between a top of each inclined plate and the partition is greater than a distance between a bottom of the inclined plate and the partition.

In some embodiments, a side of the inclined plate facing the side of the partition is either an inclined plane surface or an inclined curved surface.

In some embodiments, an upper part of the glass ribbon cavity is a V-shaped structure with a wider top and a narrower bottom; and the end of the partition is a V-shaped structure with a wider top and a narrower bottom.

In some embodiments, the first outer plate and the second outer plate are collectively referred to as outer plate; an upper guide plate is vertically arranged below each outer plate respectively; and a transverse barrier is slidably arranged between the upper guide plate and the outer plate.

A lower guide plate is vertically arranged below each upper guide plate respectively; a cutting wire is arranged between the upper guide plates and the lower guide plates, and two ends of the cutting wire are respectively connected to a cross-cutting device to cut the glass ribbon; a gripping device for grabbing the glass ribbon is arranged below the lower guide plates.

In some embodiments, an upper surface of the transverse barrier is in contact with the bottom of the outer plate, a lower surface of the transverse barrier is in contact with a top of the upper guide plate, and an outer end of the transverse barrier is connected with a telescopic device to drive the transverse barrier to slide. The double-slit structure can be formed between each transverse barrier and the partition to control the thickness of the glass ribbon; and each transverse barrier is able to contact with the partition to cut off the molten glass; a bottom of the upper guide plate is flush with a bottom of the partition (i.e., the bottom of the end of the partition).

In some embodiments, the physical property sensors and the second temperature sensors are arranged on inner walls of the upper guide plates and the lower guide plates.

In some embodiments, the top of the partition is lower than the top of each outer plate, the end of the partition is inclined toward the center, so that a longitudinal section of the partition is triangular, and a bottom of the end of the partition is flush with the bottom of the upper guide plates.

In some embodiments, the telescopic device includes a first motor, a first lead screw, a slide part and a slide seat, wherein the first motor is provided on the slide seat at a side away from the forming cavity, an output end of the first motor is connected with the first lead screw, the first lead screw is provided with a first nut, the first nut is fixedly connected to the slide part, the slide part is slidably arranged on the slide seat, and the transverse barrier is arranged on the slide part to move with the slide part under the drive of the first motor.

In some embodiments, the cross-cutting device includes a mounting plate, a second motor, a translation stand and a connecting block; wherein, the second motor is arranged on the mounting plate at a side away from the forming cavity, and a driving wheel, a driven wheel and a slide rail are arranged on the mounting plate at a side close to the forming cavity; the driving wheel and the driven wheel are respectively located at two ends of the mounting plate; an output end of the second motor is connected to the driving wheel, and the driving wheel is connected with the driven wheel through a pulley belt; a slide rail consistent with a translation direction of the pulley belt is disposed on the mounting plate, and the translation stand cooperates with the slide rail on the mounting plate through a slider; the translation stand is connected to the pulley belt through the connecting block to move with the pulley belt; a mounting block is provided on the translation stand, and an end of the cutting wire is connected to the mounting block.

In some embodiments, the cross-cutting device further includes support legs, arranged on both sides of a bottom of the mounting plate.

In some embodiments, the cross-cutting device further includes at least two photoelectric sensors and a shading plate; wherein the photoelectric sensors are arranged on the mounting plate along a translation direction of the pulley belt, and the shading plate is arranged on the translation stand. Each of the photoelectric sensors has a light-emitting element and a light-receiving element arranged opposite to each other, and a gap is formed between the light-emitting element and the light-receiving element so that the shading plate is able to pass through; a position of the cutting wire is able to be determined by the shading plate located in the gap or outside the gap.

In some embodiments, the gripping device includes a lifting device, a gear motor and a glass clamp, the gear motor is arranged on a lifting platform of the lifting device, and the glass clamp is disposed at an output end of the gear motor.

In some embodiments, the gripping device includes a lifting device capable of pushing a lifting platform up and down; the lifting platform is provided with a fourth motor; an output end of the fourth motor is connected to an input end of a gear motor, and an output end of the gear motor is connected to a glass clamp.

In some embodiments, the lifting device includes a third motor and a vertically arranged second lead screw; an output end of the third motor is connected to the second lead screw to drive to rotate; a second nut with at least one side limited is arranged on the second lead screw; and the lifting platform is located on the second nut.

In some embodiments, the glass clamp includes clamping plates and a support plate, and two clamping plates are slidably provided on a first side of the support plate, and a second side of the support plate is connected to the output end of the gear motor.

In some embodiments, the glass clamp includes a first clamping plate and a second clamping plate arranged opposite to each other, and a support plate; wherein, a first side of the support plate has two guide rails, and the first clamping plate and the second clamping plate are respectively slidably embedded in the guide rails to be limited and supported; a second side of the support plate is connected to the output end of the gear motor. The glass clamp further has a fifth motor, an output end of the fifth motor is connected to a main gear to drive to rotate; the main gear is respectively meshed with a first slave gear and a second slave gear to drive the two to rotate simultaneously; the first clamping plate is connected with a first rack meshed with the first slave gear, and the second clamping plate is connected with a second rack meshed with the second slave gear; and movement directions of the guide rails, the first rack and the second rack are parallel.

A second aspect of the present application provides a plate glass manufacturing method, which adopts the plate glass manufacturing device described in any of the above embodiments, and the manufacturing method includes:
introducing molten glass into the forming cavity between the first outer plate and the second outer plate, and dividing the molten glass in the forming cavity into two parts by the partition;
allowing the two parts of molten glass in the first cavity and the second cavity to flow towards the glass ribbon cavity simultaneously along the sides of the partition;
combining the molten glass flowing from the first cavity and the second cavity to the end of the partition, and drawing the combined molten glass downwards in the glass ribbon cavity to form a glass ribbon.

In some embodiments, during the downward flow of the molten glass in the first cavity and the second cavity, each of the first temperature sensor collects real-time temperature and transmits the collected temperature to the signal processor; the signal processor receives the collected temperature and compares with the set first target temperature; when the collected temperature is lower than the first target temperature, an instruction is sent to the first regulating electrode to adjust the temperature.

In some embodiments, when the molten glass flows in the glass ribbon cavity, each of the physical property sensor takes real-time photos and sends the taken photos to the signal processor; the signal processor analyzes parameters of the thickness, light transmittance, impurity content, and flow velocity of the glass ribbon from the taken photos, and determines whether the parameters meet the preset ranges; if not, the first regulating electrode is controlled to adjust the temperature in the forming cavity to improve these parameters. Each of the second temperature sensor collects real-time temperature and sends the collected temperature to the signal processor; the signal processor receives the collected temperature and compares with the set second target temperature; when the collected temperature is lower than the second target temperature, an instruction is sent to the first regulating electrode to adjust the temperature in the forming cavity.

More specifically, the plate glass manufacturing method includes the following steps:
Glass ribbon forming: two telescopic devices are started to control the spacing between each transverse barrier with the partition to control the thickness of the glass ribbon; the molten glass in the forming cavity flows downward along the partition and the outer plates, and is combined into one at the bottom of the partition, and then is drawn downward to form the glass ribbon;
Glass ribbon clamping: two gripping devices are started, and the glass clamp clamps the glass ribbon; the two telescopic devices are started again to control each transverse barrier to contact with the partition to cut off the molten glass;
Glass ribbon cutting: two cross-cutting devices are started synchronously, to drive the cutting wire to cut the glass ribbon in hot along the gaps between the upper guide plates and the lower guide plates;
Glass ribbon transfer: two lifting devices are started, taking the glass clamp to move downward to bring the glass ribbon out from between the two lower guide plates, and then the fourth motor and the gear motor are started to rotate the glass clamp to rotate the glass ribbon in vertical state to horizontal state for transfer.

Compared with the prior art, the present application has the following beneficial effects:

In the plate glass manufacturing device provided by at least one embodiment of the present application, by setting the forming cavity, the molten glass liquid can be accommodated and heated; by setting the partition, the forming cavity can be divided into two areas, so that the molten glass in the two areas can be drawn down along the partition to form; by setting the transverse barriers, the flow rate of the drawn molten glass can be controlled; by setting the upper guide plates and the lower guide plates, they can cooperate with each other so that the top of the drawn glass ribbon remains in hot, which is convenient for the cutting wire to cut the glass ribbon in hot; by setting the cutting wire and the cross-cutting devices, the cutting wire can move along the gaps between the upper guide plates and the lower guide plates, and cut the glass ribbon in hot, which will not generate glass dust, thus improving the glass yield rate; by setting the gripping device, the cooled glass ribbon under the lower guide plates can be grabbed and clamped, assisting the cutting wire and the cross-cutting device in cutting the glass ribbon in hot, and after cutting, the gripping device can transfer the glass ribbon; by setting the heater and temperature sensors, the temperature field of the molten glass liquid in the forming cavity can be accurately controlled, and the glass temperature field between the upper guide plates and the lower guide plates can be controlled, so as to facilitate the cutting wire and the cross-cutting device to cut the glass ribbon in hot.

The plate glass manufacturing device provided by at least one embodiment of the present application can not only efficiently cut the plate glass formed by drawing, but also can conveniently grab and transfer, effectively improving the production efficiency and yield rate of the plate glass, and reducing the production cost of the enterprise.

### BRIEF DESCRIPTION OF THE DRAWINGS

FIG. 1 is a structural diagram of plate glass manufacturing equipment in an embodiment;

FIG. 2a is a structural diagram of a double straight outer plate;

FIG. 2b is a structural diagram of a double curved outer plate;

FIG. 3 is a structural diagram of plate glass manufacturing equipment in an embodiment;

FIG. 4 is a stereogram of a transverse barrier and a telescopic device in an embodiment;

FIG. 5 is a front view of a cross-cutting device in an embodiment;

FIG. 6 is a perspective view of the cross-cutting device in an embodiment;

FIG. 7 is a perspective view of a gripping device in an embodiment;

FIG. 8 is a perspective view of the gripping device with the lifting platform hidden;

FIG. 9 is a schematic diagram of the gripping device gripping a glass ribbon in an embodiment;

FIG. 10 is a schematic diagram of a glass clamp in an embodiment;

wherein, 100 glass former body, 101 first outer plate, 102 second outer plate, 103 forming cavity, 1031 first cavity, 1032 second cavity, 1033 glass ribbon cavity, 104 partition, 1041 end of the partition, 1042 plane formed by the partition, 105 pull-down outlet of molten glass, 106 vertical plate, 107 inclined plate, 108 double straight outer plate, 109 double curved outer plate, 110 upper guide plate, 111 transverse barrier, 112 lower guide plate, 113 cutting wire;
201 first temperature sensor, 202 temperature control unit, 203 digital-to-analog converter, 204 physical property sensor and second temperature sensor, 205 signal processor;
3 telescopic device, 301 first motor, 302 first lead screw, 303 slide part, 304 slide seat, 305 screw nut;
4 cross-cutting device, 401 mounting plate, 402 second motor, 403 translation stand, 404 connecting block, 405 driving wheel, 406 driven wheel, 407 slide rail, 408 pulley belt, 409 slider, 410 mounting block, 411 support leg, 412 photoelectric sensor, 4121 light-emitting element, 4122 light-receiving element, 4123 gap, 413 shading plate;
5 gripping device, 501 lifting device, 5011 third motor, 5012 second lead screw, 5013 lifting platform, 5014 second nut, 502 gear motor, 503 glass clamp, 5031 first clamping plate, 5032 second clamping plate, 5033 support plate, 5034 fifth motor, 5035 main gear, 5036 first slave gear, 5037 second slave gear, 5038 first rack, 5039 second rack, 5040 guide rail, 504 fourth motor.

### DETAILED DESCRIPTION OF THE EMBODIMENTS

The technical solutions of the present application will be described in detail below in combination with specific embodiments. However, it should be understood that elements, structures and features in one embodiment may also be advantageously incorporated into other embodiments without further description.

In the description of the present application, it should be noted that terms such as “first” and “second” are used for descriptive purposes only, and cannot be understood as indicating or implying the relative importance, or implicitly indicating the number of indicated technical features. Therefore, the features defined with “first” and “second” may explicitly or implicitly include one or more of these features.

In the description of the present application, it should be noted that the terms “up”, “down”, “inside”, “outside”, and the like indicate the positional or positional relationship according to the positional relationship shown in FIG. 3 and merely for the convenience of describing the present application and the simplified description, but do not indicate or imply a devices or an element referred to must be of a particular orientation, constructed and operated in a particular orientation and therefore should not be construed as limiting the present application.

In the description of the present application, it should be noted that the terms “connect”, “connecting” and “connected” should be understood in a broad sense unless otherwise clearly specified and limited. For example, they might be fixed connection, detachable connection, or integrated connection; might be direct connection or indirect connection through an intermediate medium, and might be internal connection of two elements. For those of ordinary skill in the art, the specific meanings of the above-mentioned terms in the present application can be understood under specific circumstances.

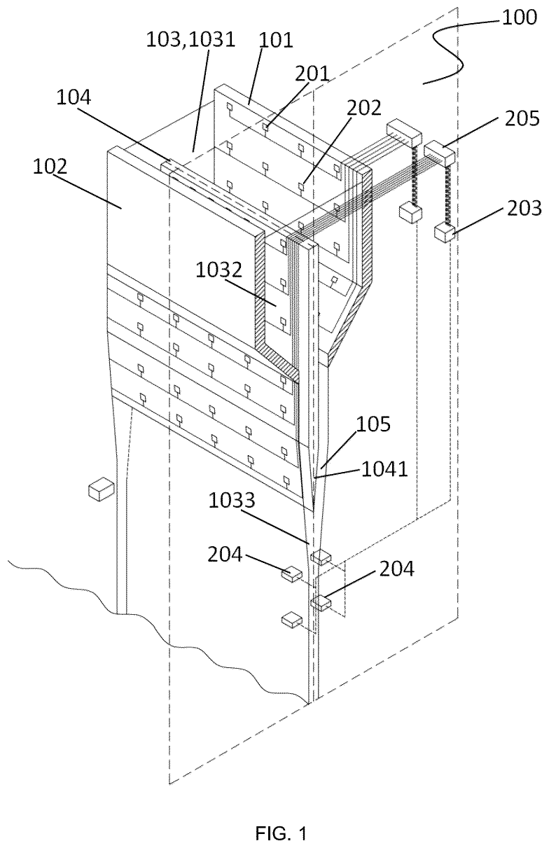

As shown in FIGS. 1-3, the first embodiment of the present application provides a plate glass manufacturing device, including a glass former body 100 for shaping molten glass; the glass former body 100 includes two outer plates symmetrically arranged at intervals, namely a first outer plate 101 and a second outer plate 102, and a forming cavity 103 is formed therebetween; the molten glass in liquid state flows from top to bottom in the forming cavity 103. A partition 104 is vertically arranged in the middle part between the first outer plate 101 and the second outer plate 102, and the partition 104 divides the upper part of the forming cavity 103 into a first cavity 1031 and a second cavity 1032.

As shown in FIG. 1 and FIG. 3, the forming cavity 103 also includes a glass ribbon cavity 1033 located at the lower part of the forming cavity 103. The end 1041 of the partition 104 is located at the upper part of the glass ribbon cavity 1033; the upper end of the glass ribbon cavity 1033 is a pull-down outlet 105 of the molten glass; the pull-down outlet 105 is a double-slit structure and is connected with the bottom of the first cavity 1031 and the bottom of the second cavity 1032. The molten glass flows from top to bottom in the first cavity and the second cavity, and the molten glass in the first cavity and the second cavity flows into the glass ribbon cavity 1033 at the same time.

The pull-down outlet 105 is located between the first cavity 1031 and the second cavity 1032 at the upper part of the forming cavity 103 and the glass ribbon cavity 1033 at the lower part of the forming cavity 103. The pull-down outlet 105 is the double-slit structure mainly refers to the width at this place, which is relatively narrow compared to the widths of the first cavity 1031, the second cavity 1032 and the glass ribbon cavity 1033; the molten glass is in a squeezed state here and then enters the glass ribbon cavity 1033 along the partition 104. As can be seen from FIG. 1 and FIG. 3, the double-slit structure of the pull-down outlet 105 is formed at the narrowest point between the two outer plates 101, 102 and the partition 104. In one embodiment, the pull-down outlet 105 is adjacent to the end 1041 of the partition, but is not located at the bottom of the end 1041 of the partition.

The molten glass enters the forming cavity 103 between the first outer plate 101 and the second outer plate 102, and the molten glass in the forming cavity 103 is divided into two parts by the partition 104; the two parts of the molten glass are respectively in the first cavity 1031 and the second cavity 1032 and flow toward the glass ribbon cavity 1033 along the sides of the partition 104; the molten glass flowing from the first cavity 1031 and the second cavity 1032 to the end 1041 of the partition (i.e., at the pull-down outlet 105) is combined at the bottom of the end of the partition and is drawn downward in the glass ribbon cavity 1033 to form a glass ribbon, as shown in FIG. 3.

The height of the top of the first outer plate 101 and the second outer plate 102 is higher than the height of the top of the partition 104; by setting the top of the partition 104 lower than the top of the outer plates, the uniformity of the molten glass on both sides of the partition 104 can be ensured. In addition, the partition 104 has two opposite sides, one side facing the first outer plate 101, and the other side facing the second outer plate 102.

The sides of the partition 104 opposite to the first outer plate 101 and the second outer plate 102 are respectively fixedly provided with first temperature sensors 201, and the sides of the first outer plate 101 and the second outer plate 102 facing the partition 104 are respectively fixedly provided with first temperature sensors 201 and temperature control units 202; both are electrically connected with a signal processor 205; the temperature control unit 202 is a first regulating electrode, located on the inner wall of the forming cavity 103, and the temperature in the forming cavity can be controlled by the regulating electrode. The regulating electrode can be directly purchased as a finished product that is sold on the market and can adjust the temperature.

The first temperature sensor 201 can realize the function of temperature measurement by using a conventional temperature sensor; the temperature control unit 202 can adopt hardware capable of temperature adjustment such as a regulating electrode; and the signal processor 205 adopts a CPU, a single-chip microcomputer, a PLC, an MCU, an FPGA and other hardware devices capable of realizing corresponding functions. The present embodiment also includes a memory and at least one program, wherein the at least one program is stored in the memory and configured to be executed by the signal processor 205; the at least one program includes:
The first temperature sensor 201 receives instructions for collecting real-time temperature and transmitting the collected temperature to the signal processor 205;
The signal processor 205 receives the temperature collected by the temperature sensor 201 and compares it with a set first target temperature; when the collected temperature is lower than the first target temperature, an instruction is sent to the first regulating electrode;
The first regulating electrode receives the instruction from the signal processor 205 and adjusts the temperature.

The first target temperature is set according to actual needs in order to control the temperature of the molten glass in the first cavity 1031 and the second cavity 1032.

The molten glass is located in the forming cavity 103. The flow and temperature regulation of the molten glass in the first cavity 1031 and the second cavity 1032 are realized by the temperature control unit 202 arranged on the inner wall thereof; the heating device is small in size, the loss of heat energy flow is reduced, energy consumption is reduced, and the product output efficiency is improved. The first temperature sensors 201 arranged on the sides of the partition 104 and the inner surfaces of the outer plates can measure the temperature of the molten glass flowing therein; the temperature measurement data is fed back to the signal processor 205, the signal processor 205 controls the temperature control unit 202 to heat, flexibly adjusting the temperature of the molten glass as it flows. The interior of the forming cavity 103 is fully provided with the first regulating electrodes, which can be controlled to adjust the temperature in different areas, thus the physical properties of the molten glass are effectively adjusted, the texture in the forming process is reduced, and the occurrence of defective products is reduced. The contact surface with the outside is reduced in the drawing process, only limited to pull-down outlet, which reduces the adhesion of pollutants and improves the physical properties of the output product.

The two sides of the glass ribbon cavity 1033 are respectively fixedly provided with physical property sensors and second temperature sensors 204, and the physical property sensors and the second temperature sensors 204 are both electrically connected with the signal processor 205. The physical property sensor adopts a camera. The second temperature sensor can adopt a conventional temperature sensor. The at least one program also includes:

The physical property sensor receives instructions for taking real-time photos and sending the taken photos to the signal processor 205;

The signal processor 205 receives the photos taken by the physical property sensor, analyzes the thickness, light transmittance, impurity content, flow velocity, and other parameters of the glass ribbon, and determines whether these parameters meet the preset range; if no, the first regulating electrode is controlled to improve these parameters by adjusting the temperature of different areas in the forming cavity 103.

The second temperature sensor receives instructions for collecting real-time temperature and transmitting the collected temperature to the signal processor 205;

The signal processor 205 also receives the temperature collected by the second temperature sensor and compares it with a set second target temperature; when the collected temperature is lower than the second target temperature, an instruction is sent to the first regulating electrode;

The first regulating electrode receives the instruction from the signal processor 205 and adjusts the temperature in the forming cavity.

The second target temperature is set according to actual needs in order to control the temperature of the glass ribbon in the glass ribbon cavity 1033.

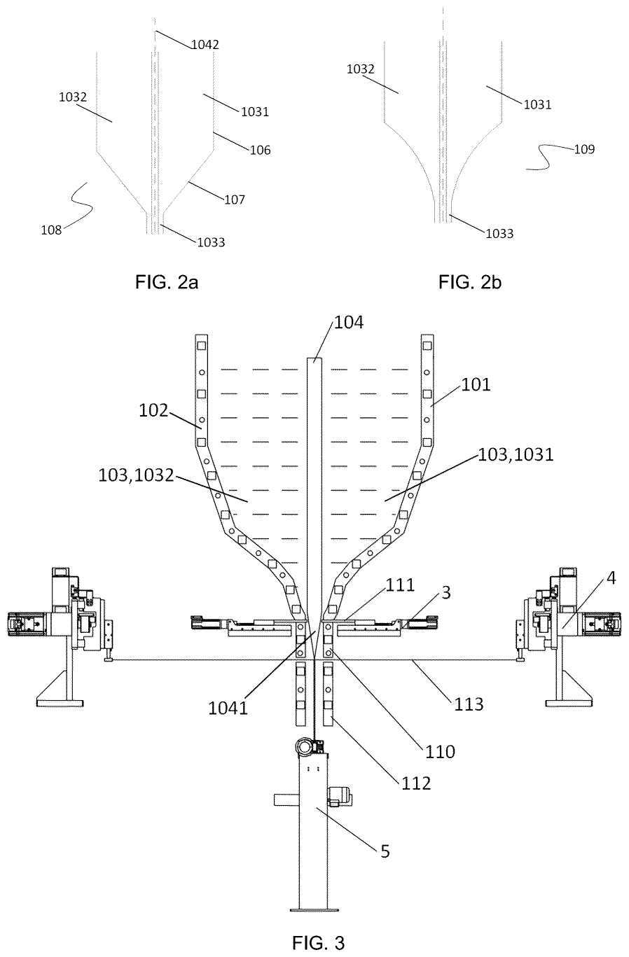

The first outer plate 101 and the second outer plate 102 are both bent shape and have the same structure; as shown in FIG. 2a, each outer plate includes a vertical plate 106 and an inclined plate 107, the inclined plate 107 is located at the bottom of the vertical plate 106, and the distance between the top of the inclined plate 107 and the partition 104 is greater than the distance between the bottom of the inclined plate 107 and the partition 104; that is, the forming cavity 103 gradually decreases from top to bottom. The side of the inclined plate 107 facing the side of the partition 104 is either an inclined plane surface or an inclined curved surface.

As shown in FIG. 2a and FIG. 2b, the upper part of the glass ribbon cavity 1033 is a roughly V-shaped structure with a wider top and a narrower bottom. As shown in FIG. 1 and FIG. 3, the end 1041 of the partition is a V-shaped structure with a wider top and a narrower bottom; and it is convenient to guide the molten glass to flow into the glass ribbon cavity 1033 from top to bottom along the partition 104.

The glass former body 100 includes the first outer plate 101 and the second outer plate 102, which are used to draw the molten glass in a liquid state produced in a previous process downward along the central plane (i.e., the plane 1042 formed by the partition) of the glass former body 100 to form a glass ribbon. The partition 104 is used to divide the molten glass from the previous process into two zones (i.e., the first cavity and the second cavity) in the forming cavity 103. At the end 1041 of the partition, the molten glass in the first cavity 1031 and the second cavity 1032 are combined into one, and then drawn downward at the glass ribbon cavity 1033 to form a glass ribbon. The height of the partition 104 is slightly lower than the first outer plate 101 and the second outer plate 102 to ensure that the molten glass on both sides is uniform. The shapes of the inclined plates 107 of the first outer plate 101 and the second outer plate 102 at the upper part of the glass former body 100 can be: the double straight outer plate 108 of the inclined plane surfaces formed on the sides facing the sides of the partition 104, as shown in FIG. 2a; or the double curved outer plate 109 of the inclined curved surfaces on the sides facing the sides of the partition 104, as shown in FIG. 2b. The double curved outer plate 109 can ensure that the molten glass maintains better fluidity and uniformity. The glass former body 100, the inner walls of both sides and the outer walls on both sides of the partition 104 (i.e., the two sides) are equipped with first temperature sensors 201 and temperature control units 202, which are divided into multiple areas in the horizontal and vertical directions.

The related signals of different sensing areas are transmitted to the signal processor 205 through the digital-to-analog converter 203, and then the temperature control units 202 (first regulating electrodes) of different areas are controlled to adjust the temperature to ensure the fluidity and physical properties of the molten glass in different areas. At the same time, below the end 1041 of the partition, the molten glass on both sides is drawn and merged to form a glass ribbon. Four sets of physical property sensor and second temperature sensor 204 are provided on both sides of the glass ribbon to sense the physical properties of the glass ribbon (including temperature, transmittance, thickness, flow rate, etc.), and the signal is fed back to the signal processor 205. Then the temperature control units in different areas are controlled to adjust the temperature to ensure the fluidity and physical properties of the glass liquid in different areas.

In one embodiment, as shown in FIG. 3, two upper guide plates 110 corresponding to the first outer plate 101 and the second outer plate 102 are vertically arranged at the outlet of the bottom of the upper part of the forming cavity 103 (i.e., the bottom of the first cavity 1031 and the second cavity 1032), and a transverse barrier 111 is respectively slidably arranged between the upper guide plates 110 with the first outer plate 101 and the second outer plate 102.

The pull-down outlet 105 of the molten glass can be formed between the transverse barriers 111 and the partition 104, which is used to control the thickness of the glass ribbon. For example, if a glass ribbon with a thickness of 5 mm is desired, the spacing between each transverse barrier 111 and the partition 104 can be controlled to be 2.5 mm, so that the thickness of the glass ribbon formed by the molten glass reaching the bottom of the partition 104 is 5 mm. In the present embodiment, the gaps between the transverse barriers 111 and the partition 104 are the double-slit structure.

In addition, the transverse barrier 111 is able to contact with the partition 104 to cut off the molten glass. When the cutting device is cutting, the molten glass is prevented from continuing to enter the glass ribbon cavity 1033.

The bottom of the upper guide plate 110 is roughly flush with the bottom of the partition 104 (i.e., the bottom of the end of the partition).

Two lower guide plates 112 are correspondingly provided below the two upper guide plates 110; a cutting wire 113 is provided between the upper guide plates 110 and the lower guide plates 112; the cutting wire 113 can be a platinum cutting wire; and the two ends of the cutting wire 113 are each connected to a cross-cutting device 4, to drive the cutting wire 113 to cut the preliminarily formed glass ribbon.

A gripping device 5 is provided below the lower guide plates 112.

The space formed between the two upper guide plates 110 constitutes a part of the glass ribbon cavity 1033; and the space formed between the two lower guide plates 112 also constitutes a part of the glass ribbon cavity 1033.

The physical property sensors and the second temperature sensors 204 are arranged on the inner walls of the upper guide plates 110 and the lower guide plates 112 to monitor the physical property parameters and temperature of the glass ribbon.

Second regulating electrodes can also be arranged inside the upper guide plates 110 and the lower guide plates 112, to regulate the temperature in the glass ribbon cavity. The temperature of the glass ribbon in the glass ribbon cavity might affect the final forming effect of the glass ribbon; therefore, temperature regulation is provided here.

By setting the transverse barriers 111, the flow rate of the drawing molten glass can be controlled. By setting the upper guide plates 110 and the lower guide plates 112, they can cooperate with each other so that the top of the drawn glass ribbon remains in a hot state, which is convenient for the cutting wire 113 to cut the glass ribbon in hot. By setting the cutting wire 113 and the cross-cutting device 4, the cutting wire can move along the gaps between the upper guide plates 110 and the lower guide plates 112, and cut the glass ribbon in hot in the middle, which will not generate glass dust, thereby improving the glass yield. By setting the gripping device 5, the glass ribbon part that has been cooled below the lower guide plates 112 can be grabbed, and the cutting wire 113 and the cross-cutting device 4 can be assisted to cut the glass ribbon in hot, and after the cutting is completed, the gripping device 5 can transfer it. By setting the physical property sensors, the second temperature sensors and the second regulating electrodes, the temperature field of the entire molten glass can be accurately controlled, and the temperature field of the glass ribbon between the upper guide plates 110 and the lower guide plates 112 can be controlled, so as to facilitate the cutting wire 113 and the cross-cutting device 4 to cut the glass in hot.

The end 1041 of the partition is inclined toward the center, and the longitudinal section of the end of the partition is roughly triangular (the V-shaped structure described above), and the bottom is flush with the bottoms of the upper guide plates 110. The triangular arrangement enables the pulled molten glass liquid to be reunited at the bottom of the end 1041 of the partition, effectively reducing the internal stress; by setting the bottom of the partition 1041 flush with the bottoms of the upper guide plates 110, the cutting effect of the cutting wire 113 can be improved.

As shown in FIG. 3, the upper surface of each transverse barrier 111 is in close contact with the bottom of the corresponding outer plate, and the lower surface of the transverse barrier 111 is in close contact with the top of the corresponding upper guide plate 110, which can prevent the leakage of molten glass liquid; an outer end of the transverse barrier 111 is connected with a telescopic device 3 to drive the transverse barrier 111 to slide left and right, so as to approach or move away from the partition 104, so as to control the outflow thickness of the molten glass, and then control the thickness of the glass ribbon, which can be used to produce glass ribbons with different thickness requirements; and the transverse barrier 111 can also be controlled to contact with the partition 104 to cut off the molten glass.

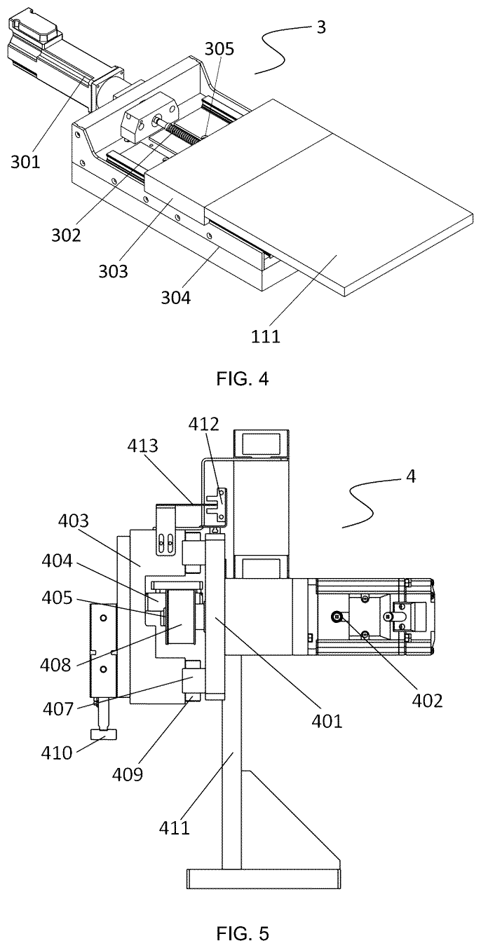

In a specific embodiment, as shown in FIG. 4, the telescopic device 3 includes a first motor 301, a first lead screw 302, a slide part 303 and a slide seat 304. Among them, the first motor 301 is provided on the slide seat 304 at a side away from the forming cavity 103, and the output end of the first motor 301 is connected with the first lead screw 302; a screw nut 305 (i.e., a first nut, which is fixed at a side of the slide part 303 or below the slide part 303) is provided on the first lead screw 302, and the screw nut 305 is fixedly connected to the middle part of the slide part 303; both sides of the slide part 303 are slidably arranged on the slide seat 304; and the transverse barrier 111 is arranged on the slide part 303 to move with the slide part 303 under the drive of the first lead screw 302. By setting the first motor 301, the first lead screw 302 can be driven to rotate; by setting the first lead screw 302 and the screw nut 305, the slide part 303 can be pushed to slide linearly on the slide seat 304, and the rotational motion of the first lead screw is converted into the linear motion of the slide part, thereby driving the transverse barrier 111 to slide between the upper guide plates 110 and the first outer plate 101 and the second outer plate 102, and accurately controlling the flow of the molten glass pulled down. In addition, the slide part 303 and the slide seat 304 are in a sliding connection relationship, which can be realized by a variety of manners, such as the manner of slide rail and slider, the manner of bearing movement, etc., which are well known to the ordinary skills in the mechanical field. In addition, the telescopic device 3 can also adopt other prior mechanical or electronic control products that can push the horizontal movement of the transverse barrier 111.

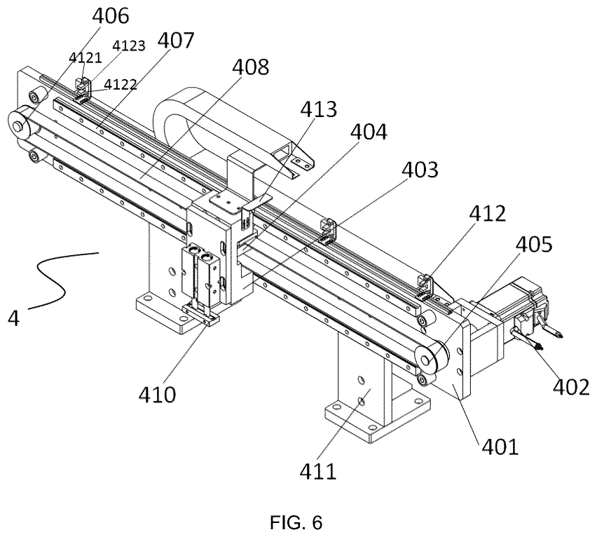

As shown in FIG. 5 and FIG. 6, the cross-cutting device 4 includes a mounting plate 401, a second motor 402, a translation stand 403 and a connecting block 404; wherein, the second motor 402 is provided on the mounting plate 401 at a side away from the forming cavity 103, a driving wheel 405, a driven wheel 406 and slide rails 407 are provided on the mounting plate 401 at a side close to the forming cavity 103. The driving wheel 405 and the driven wheel 406 are respectively located at two ends of the mounting plate 401 in the transverse direction. The output end of the second motor 402 is connected with the driving wheel 405 to drive the driving wheel 405 to rotate; the driving wheel 405 is connected with the driven wheel 406 through a pulley belt 408. The slide rails 407 are provided above and below the pulley belt 408; the slide rails 407 are installed on the mounting plate 401 and are consistent with the translation direction of the pulley belt 408. The top part and bottom part of the translation stand 403 cooperate with the slide rails 407 on the mounting plate 401 through sliders 409. The middle part of the translation stand 403 is connected with the pulley belt 408 through the connecting block 404 to move with the pulley belt 408. A mounting block 410 is arranged on the translation stand 403, and the end of the cutting wire 113 is connected to the mounting block 410 to fix the cutting wire 113 on the cross-cutting device 4 and move with the translation stand 403.

By setting the mounting plate 401, the second motor 402, the translation stand 403, the driving wheel 405, the driven wheel 406 and the slide rails 407 can be installed; the present embodiment enables the second motor 402 to drive the translation stand 403 to perform reciprocating linear motion through the pulley belt 408, thereby driving the mounting block 410 and the cutting wire 113 to perform reciprocating linear motion to cut the glass in hot; by setting the slide rails 407 and the sliders 409, the stability of the movement of the translation stand 403 can be ensured, and the cutting quality can be improved.

As shown in FIG. 6, the cross-cutting device 4 may also include support legs 411, arranged on two sides of the bottom of the mounting plate 401. By setting the support legs 411, the mounting plate 401 can be stably supported. In addition, the cross-cutting device 4 may also include a plurality of photoelectric sensors 412 and a shading plate 413; wherein the photoelectric sensors 412 are arranged on the top of the mounting plate 401, and slot-type photoelectric sensors may be adopted; the shading plate 413 is arranged on the translation stand 403, and the shading plate 413 cooperates with the photoelectric sensors 412. By arranging the photoelectric sensors 412 and the shading plate 413, the position of the translation stand 403 can be monitored in real time, so as to judge the position of the cutting wire 113 and the cutting progress of the glass.

In one embodiment, the distance between the two working photoelectric sensors 412 is slightly larger than the width of the glass ribbon to be cut, so that after the glass ribbon is cut, the cross-cutting device 4 can be controlled to stop working. Specifically, each photoelectric sensor 412 is connected with the signal processor 205 respectively. Each photoelectric sensor 412 has a light-emitting element 4121 and a light-receiving element 4122 arranged opposite to each other, and a gap 4123 is formed therebetween, through which the shading plate 413 can pass. The light-emitting element 4121 can emit visible light such as infrared light; when the gap 4123 is unobstructed, the light-receiving element 4122 can receive the light emitted by the light-emitting element 4121, and the signal processor 205 does not make a judgment; when the shading plate 413 enters into the gap 4123, the emitted light is blocked, and the light-receiving element 4122 cannot receive the light; the signal processor 205 can obtain the signal, thereby controlling the second motor 402 to start or stop working, and the cutting wire 113 to start or stop cutting. The working principle of the photoelectric sensors 412 and the shading plate 413 belongs to the conventional technical method in the electric control field, which is very easy to implement.

As shown in FIG. 6, three photoelectric sensors are provided, the first photoelectric sensor on the left is the initial end, the second photoelectric sensor and the third photoelectric sensor from the left are both stop ends, and the width between the first photoelectric sensor and the third photoelectric sensor at two ends is slightly larger than the maximum width of the glass strip that can be cut; the second photoelectric sensor in the middle is movably arranged on the mounting plate 401, and by adjusting the width to the first photoelectric sensor (at this time, the third photoelectric sensor does not work), it can be applied to the cutting of glass strips of various widths. When the shading plate 413 reaches the first photoelectric sensor, the signal processor 205 can determine that the translation stand 403 is at the initial end, thereby controlling the second motor 402 to start working; when the shading plate 413 reaches the second photoelectric sensor or the third photoelectric sensor, the signal processor 205 can determine that the translation stand 403 is at the stop end (cutting is completed), thereby controlling the second motor 402 to stop working. Through this setting, the positions of the cutting wire 113 and the translation stand 403 can also be determined, thereby determining the positions of the two and the cutting progress.

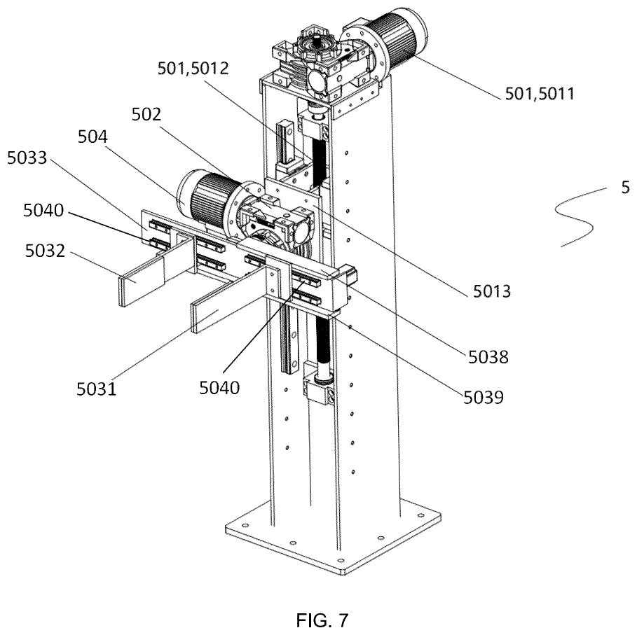

As shown in FIG. 7-9, the gripping device 5 includes a lifting device 501, a gear motor 502 and a glass clamp 503; wherein, the gear motor 502 is arranged on a lifting platform 5013 of the lifting device 501, and an output end of the gear motor 502 is provided with the glass clamp 503. By setting the lifting device 501, the height position of the gear motor 502 and the glass clamp 503 can be adjusted, so as to clamp the glass and transfer the glass; by setting the gear motor 502, the spatial state of the glass clamp and the glass can be adjusted, and the glass can be adjusted from a vertical state to a horizontal state, which is convenient for subsequent transportation; by setting the glass clamp 503, the glass can be stably clamped.

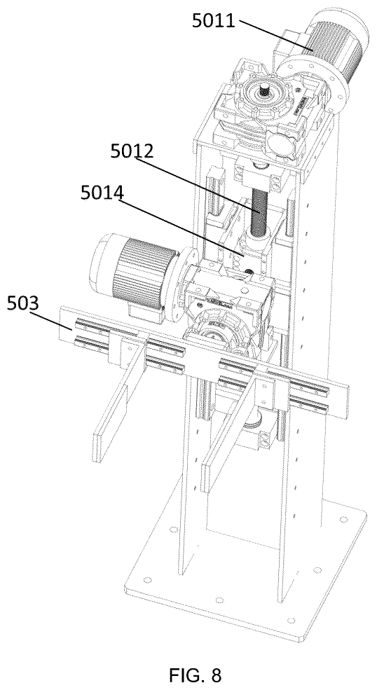

In a specific embodiment, as shown in FIG. 7 and FIG. 8, wherein the lifting platform 5013 is hidden in FIG. 8 to show the second nut 5014; the lifting device 501 includes a third motor 5011 and a vertically arranged second lead screw 5012. The third motor 5011 can be a servo motor, and an output end thereof is connected with the second lead screw 5012 to drive it to rotate. A second nut 5014 is provided on the second lead screw 5012, and at least one side of the second nut 5014 is limited so that it can only move up and down with the second lead screw 5012. The lifting platform 5013 is connected with the second nut 5014 to move up and down with it. In addition, the lifting device 501 can also use other mechanical or electric control devices that can achieve lifting, such as piston rod pushing, etc., to achieve the up and down movement of the lifting platform 5013.

The lifting platform 5013 of the lifting device 501 is provided with a fourth motor 504 that can move up and down with the lifting platform, which can be a servo motor, and the output end of the fourth motor is connected with the input end of the gear motor 502, and the output end of the gear motor 502 is connected with the glass clamp. The gear motor 502 is able to perpendicularly convert the output direction of the fourth motor 504, so as to control the glass clamp 503 to rotate, for example, from the vertical direction to the horizontal direction.

As shown in FIG. 7, the glass clamp 503 includes two opposite arranged clamping plates (i.e., the first clamping plate 5031 and the second clamping plate 5032) for clamping the glass ribbon and a support plate 5033; wherein, a first side of the support plate 5033 is slidably provided with the two clamping plates 5031, 5032, and a second side of the support plate 5033 opposite to the first side is connected with the output end of the gear motor 502, so that the gear motor 502 can control the rotation of the support plate 5033, thereby causing the clamping plates to drive the glass ribbon to rotate.

In order to make the two clamping plates 5031, 5032 slidably disposed on the support plate 5033, in a specific embodiment, as shown in FIG. 7 and FIG. 10, the glass clamp 503 further includes a fifth motor 5034 (a servo motor may be selected) and a main gear 5035; the output end of the fifth motor 5034 is connected with the main gear 5035 to drive the main gear 5035 to rotate. The main gear 5035 is also meshed with a first slave gear 5036 and a second slave gear 5037 respectively to drive them to rotate. The two slave gears 5036, 5037 may be rotatably disposed on the second side of the support plate 5033 via pin shafts or the like. The first clamping plate 5031 is connected with a first rack 5038, and the first rack 5038 is meshed with the first slave gear 5036 to drive the first rack 5038 to move, thereby driving the first clamping plate 5031 to slide. The second clamping plate 5032 is connected with a second rack 5039, and the second rack 5039 is meshed with the second slave gear 5037 to drive the second rack 5039 to move, thereby driving the second clamping plate 5032 to slide. The two racks 5038 and 5039 are arranged in parallel. Further, the first slave gear 5036 and the second slave gear 5037 are respectively located at opposite sides of the main gear 5035; and in FIG. 10, the first slave gear 5036 is at the upper side and the second slave gear 5037 is at the lower side; thereby, the movement directions of the two racks are opposite, causing the two clamping plates to approach or move away from each other. For example, in FIG. 10, when the main gear 5035 rotates clockwise, the first slave gear 5036 rotates counterclockwise, driving the first rack 5038 and the first clamping plate 5031 to move to the left side; at this time, the second slave gear 5037 rotates counterclockwise, driving the second rack 5039 and the second clamping plate 5032 to move to the right side; thereby, the two clamping plates move away from each other; conversely, when the main gear 5035 rotates counterclockwise, the two clamping plates move closer to each other.

In addition, as shown in FIG. 7, two guide rails 5040 are also provided on the first side of the support plate 5033. The extension direction of each guide rail 5040 is parallel to the movement direction of the first rack 5038 and the second rack 5039. The backs of the two clamping plates can be respectively embedded in the two guide rails 5040 through sliders (not shown in the figure) to slide along the guide rails, thereby limiting and supporting the sliding of the clamping plates. When the two guide rails 5040 are extended and merged, they can also be regarded as one guide rail.

By setting the clamping plates and the support plate 5033, the conventional glass suction cups can be replaced. The two clamping plates 5031, 5032 slide on the support plate 5033 to stably clamp the glass from both sides; the service life is long and regular replacement is not required, which reduces production costs and improves production efficiency. In addition, with the development of robot technology, the gripping device 5 in the present application can also be directly purchased or customized as a robot arm to achieve the gripping of the formed glass ribbon.

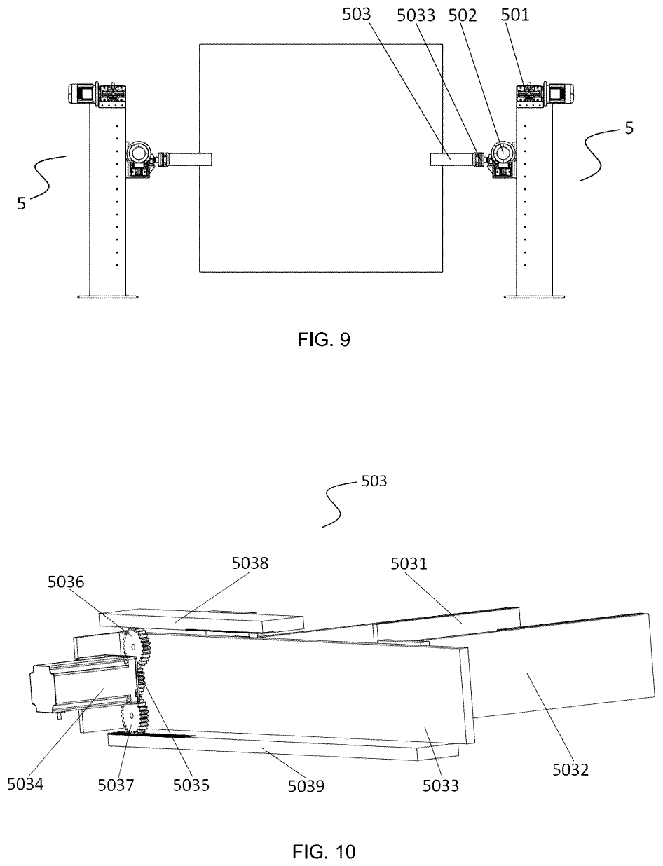

In the present embodiment, as shown in FIG. 3, there are two telescopic devices 3, respectively connected to two transverse barriers 111, to throttle the molten glass from opposite sides. There are also two cross-cutting devices 4, respectively fixing the two ends of the cutting wire 113, and moving the cutting wire in the front and rear directions in FIG. 3 to cut the preliminarily formed glass ribbon. As shown in FIG. 9, there are two gripping devices, which can grab the same glass ribbon from two directions, with better stability. In addition, it is to be understanding that the various motors in the present application can select servo motors with better control accuracy according to actual needs, or other motors that meet the needs.

A second embodiment of the present application provides a plate glass manufacturing method, which can adopt the plate glass manufacturing device described in any of the above embodiments, and the manufacturing method includes:
the molten glass enters the forming cavity between the first outer plate 102 and the second outer plate 103, and the molten glass in the forming cavity 113 is divided into two parts by the partition 105;
the two parts of the molten glass are respectively in the first cavity 1031 and the second cavity 1032 and flow toward the glass ribbon cavity 1033 along the sides of the partition 105;
the molten glass flowing from the first cavity 1031 and the second cavity 1032 to the end 1041 of the partition is combined into one and is drawn downward in the glass ribbon cavity 1033 to form a glass ribbon.

During the downward flow of the molten glass in the first cavity 1031 and the second cavity 1032, the fluidity of the molten glass can also be controlled by the first temperature sensors 201 and the temperature control units 202.

During the flow of molten glass in the glass ribbon cavity 1033, the physical properties of the glass ribbon can also be sensed by the physical property sensors and the second temperature sensors 204, and the signal is fed back to the signal processor 205, and the signal processor 205 controls the temperature control units in different areas to control the fluidity of the molten glass in the forming cavity.

In a more specific embodiment, the plate glass manufacturing method includes the following steps:
S1, glass ribbon forming: control the spacing between the two transverse barriers 111 with the partition 104 to control the thickness of the glass ribbon; the molten glass in the forming cavity 103 flows downward along the first cavity 1031 and the second cavity 1032, and is combined at the bottom of the end 1041 of the partition, and then is drawn downward to form the glass ribbon; after the glass ribbon is formed between the two upper guide plates 110 and the two lower guide plates 112, the glass ribbon keeps moving downward, and when the glass ribbon reaches the glass clamp of the gripping device 5, the two telescopic devices 3 synchronously control the two transverse barriers 111 to move horizontally, each of the first motor 301 drives the first lead screw 302 to rotate, and the screw nut 305 drives the slide part 303 to slide on the slide seat 304, and the slide part 303 drives the transverse barrier 111 to move horizontally, so that the two transverse barriers 111 synchronously move horizontally toward the partition 104 to cut off the molten glass;
S2, glass ribbon clamping: the gripping device 5 starts working, the glass clamp 503 clamps the glass ribbon, and the fifth motor 5034 pushes the two clamping plates to slide synchronously along the support plate 5033 to the center through the gears and racks, and clamps the glass ribbon between the two clamping plates;
S3, glass ribbon cutting: the two cross-cutting devices 4 start synchronously, each of the second motor 402 drives the driving wheel 405 to rotate, so that the pulley belt 408 rotates between the driving wheel 405 and the driven wheel 406, and the pulley belt 408 drives the translation stand 403 to move horizontally on the slide rails 407 through the connecting block 404, so that the mounting blocks 410 of the two translation stands 403 drive the cutting wire 113 together to cut the glass ribbon in hot along the gaps between the upper guide plates 110 and the lower guide plates 112, and to separate the formed glass ribbon from the molten glass on the partition 104;
S4, glass ribbon transfer: the lifting device 501 starts working, driving the glass clamp 503 to move downward, and taking the glass ribbon out between the two lower guide plates 112; the fourth motor 504 and the gear motor 502 start working, and rotating the glass clamp 503 to rotate the glass ribbon in the vertical state to the horizontal state, which is convenient for removal and transfer for secondary processing.

The embodiments are only described as preferred embodiments of the present application, and are not intended to limit the scope of the present application. Various modifications and improvements made on the technical solutions of the present application by ordinary skills in the art without departing from the design spirit of the present application shall fall within the protective scope confirmed by the claims of the present application.

1. A plate glass manufacturing device, wherein, comprising a glass former body for shaping molten glass; and the glass former body comprises:
a first outer plate and a second outer plate arranged symmetrically at intervals, a forming cavity is formed between the first outer plate and the second outer plate, and the molten glass flows from top to bottom in the forming cavity;
a partition vertically arranged in a middle part between the first outer plate and the second outer plate, and the partition divides an upper part of the forming cavity into a first cavity and a second cavity;
the forming cavity further includes a glass ribbon cavity located at a lower part of the forming cavity, wherein an end of the partition is located at an upper part of the glass ribbon cavity, an upper end of the glass ribbon cavity is a pull-down outlet of the molten glass, and the pull-down outlet is a double-slit structure and is communicated with a bottom of the first cavity and a bottom of the second cavity respectively; and
the molten glass flows from top to bottom in the first cavity and the second cavity, and the molten glass in the first cavity and the second cavity flows into the glass ribbon cavity simultaneously;
the first outer plate and the second outer plate are collectively referred to as outer plate; an upper guide plate is vertically arranged below each outer plate respectively; a transverse barrier is slidably arranged between the upper guide plate and the outer plate; a lower guide plate is vertically arranged below each upper guide plate respectively; a cutting wire is arranged between the upper guide plates and the lower guide plates, and two ends of the cutting wire are respectively connected to a cross-cutting device to cut the glass ribbon; and a gripping device for grabbing the glass ribbon is arranged below the lower guide plates.

2. The plate glass manufacturing device according to claim 1, wherein, tops of the first outer plate and the second outer plate are higher than a top of the partition; sides of the partition facing the first outer plate and the second outer plate are fixedly provided with first temperature sensors respectively; side of the first outer plate facing the partition and side of the second outer plate facing the partition are fixedly provided with first temperature sensors and first regulating electrodes respectively; the first temperature sensors and first regulating electrodes are electrically connected with a signal processor; and physical property sensors are fixedly arranged on both sides of the glass ribbon cavity, and the physical property sensors are electrically connected to the signal processor.

3. The plate glass manufacturing device according to claim 1, wherein, the first outer plate and the second outer plate are both bent shape and have the same structure, and each of the first outer plate and the second outer plate includes a vertical plate and an inclined plate respectively, each inclined plate is located at a bottom of the vertical plate, and a distance between a top of each inclined plate and the partition is greater than a distance between a bottom of the inclined plate and the partition; a side of the inclined plate facing the side of the partition is either an inclined plane surface or an inclined curved surface; and an upper part of the glass ribbon cavity is a V-shaped structure with a wider top and a narrower bottom; and the end of the partition is a V-shaped structure with a wider top and a narrower bottom.

4. The plate glass manufacturing device according to claim 1, wherein, an upper surface of the transverse barrier is in contact with a bottom of the outer plate, a lower surface of the transverse barrier is in contact with a top of the upper guide plate, and an outer end of the transverse barrier is connected with a telescopic device to drive the transverse barrier to slide; the double-slit structure is able to be formed between each transverse barrier and the partition to control the thickness of the glass ribbon; and each transverse barrier is able to contact with the partition to cut off the molten glass; a bottom of the upper guide plate is flush with a bottom of the end of the partition.

5. The plate glass manufacturing device according to claim 4, wherein, the telescopic device includes a first motor, a first lead screw, a slide part and a slide seat, wherein the first motor is provided on the slide seat at a side away from the forming cavity, an output end of the first motor is connected with the first lead screw, the first lead screw is provided with a first nut, the first nut is fixedly connected to the slide part, the slide part is slidably arranged on the slide seat, and the transverse barrier is arranged on the slide part to move with the slide part under the drive of the first motor.

6. The plate glass manufacturing device according to claim 1, wherein, the cross-cutting device includes a mounting plate, a second motor, a translation stand and a connecting block; wherein, the second motor is arranged on the mounting plate at a side away from the forming cavity, and a driving wheel, a driven wheel and a slide rail are arranged on the mounting plate at a side close to the forming cavity; the driving wheel and the driven wheel are respectively located at two ends of the mounting plate; an output end of the second motor is connected to the driving wheel, and the driving wheel is connected with the driven wheel through a pulley belt; a slide rail consistent with a translation direction of the pulley belt is disposed on the mounting plate, and the translation stand cooperates with the slide rail on the mounting plate through a slider; the translation stand is connected to the pulley belt through the connecting block to move with the pulley belt; and a mounting block is provided on the translation stand, and an end of the cutting wire is connected to the mounting block.

7. The plate glass manufacturing device according to claim 6, wherein, the cross-cutting device further includes at least two photoelectric sensors and a shading plate; wherein, the photoelectric sensors are arranged on the mounting plate along a translation direction of the pulley belt, and the shading plate is arranged on the translation stand; each of the photoelectric sensors has a light-emitting element and a light-receiving element arranged opposite to each other, and a gap is formed between the light-emitting element and the light-receiving element so that the shading plate is able to pass through; and a position of the cutting wire is able to be determined by the shading plate located in the gap or outside the gap.

8. The plate glass manufacturing device according to claim 1, wherein, the gripping device includes a lifting device capable of pushing a lifting platform up and down, a gear motor and a glass clamp; wherein, the lifting platform is provided with a fourth motor, an output end of the fourth motor is connected to an input end of the gear motor, and an output end of the gear motor is connected to the glass clamp; the glass clamp includes a first clamping plate and a second clamping plate arranged opposite to each other, and a support plate; wherein, a first side of the support plate has two guide rails, and the first clamping plate and the second clamping plate are respectively slidably embedded in the guide rails to be limited and supported; a second side of the support plate is connected to the output end of the gear motor; the glass clamp further has a fifth motor, an output end of the fifth motor is connected to a main gear to drive to rotate; the main gear is respectively meshed with a first slave gear and a second slave gear to drive the slave gears to rotate simultaneously; the first clamping plate is connected with a first rack meshed with the first slave gear, and the second clamping plate is connected with a second rack meshed with the second slave gear; and movement directions of the guide rails, the first rack and the second rack are parallel.

9. A plate glass manufacturing method, adopting the plate glass manufacturing device according to claim 1, wherein, the manufacturing method includes:
introducing molten glass into the forming cavity between the first outer plate and the second outer plate, and dividing the molten glass in the forming cavity into two parts by the partition;
allowing the two parts of the molten glass in the first cavity and the second cavity to flow towards the glass ribbon cavity simultaneously along the sides of the partition;
combining the molten glass flowing from the first cavity and the second cavity to the end of the partition, and drawing the combined molten glass downwards in the glass ribbon cavity to form a glass ribbon.

10. The plate glass manufacturing method according to claim 9, wherein, more specifically, including the following steps:
glass ribbon forming: two telescopic devices are started to control the spacing between each transverse barrier with the partition to control the thickness of the glass ribbon; the molten glass in the forming cavity flows downward along the partition and the outer plates, and is combined into one at the bottom of the partition, and then is drawn downward to form the glass ribbon;
glass ribbon clamping: two gripping devices are started, and the glass clamp clamps the glass ribbon; and the two telescopic devices are started again to control each transverse barrier to contact with the partition to cut off the molten glass;
glass ribbon cutting: two cross-cutting devices are started synchronously, to drive the cutting wire to cut the glass ribbon in hot along the gaps between the upper guide plates and the lower guide plates;
glass ribbon transfer: two lifting devices of the two gripping devices are started, taking the glass clamp to move downward to bring the glass ribbon out from between the two lower guide plates, and then the gear motors of the two gripping devices are started to rotate the glass clamp to rotate the glass ribbon in vertical state to horizontal state for transfer.
